(19) United States
(12) Patent Application Publication
(10) Pub. No.: US 2022/0057811 A1
(43) Pub. Date: Feb. 24, 2022

(54) MOBILE AUTONOMOUS FLEET CONTROL

(71) Applicant: Hewlett-Packard Development Company, L.P., Spring, TX (US)

(72) Inventors: William J. Allen, Corvallis, OR (US); Jonathan M. Salfity, Palo Alto, CA (US)

(73) Assignee: Hewlett-Packard Development Company, L.P., Spring, TX (US)

(21) Appl. No.: 17/413,894

(22) PCT Filed: Dec. 14, 2018
(86) PCT No.: PCT/US2018/065847

§ 371 Date: Jun. 14, 2021

(51) Int. Cl. G05D 1/02

(52) U.S. Cl. CPC G05D 1/0295; G05D 1/0293

(57) ABSTRACT

A mobile autonomous fleet control system may include a central control unit to communicate with a mobile master unit. The mobile master unit is to autonomously navigate. The central control unit is to issue a follow command to each mobile self-propelled slave unit of a fleet of mobile self-propelled slave units. The follow command uniquely identifies the mobile master unit to be followed.

### BACKGROUND

Mobilized service devices are sometimes utilized to provide a service at a particular location. Mobilized service devices may contain propulsion units to travel to and from the location. Such propulsion may be over the ground, through water or through the air. Such mobilized service devices may include sensors and navigation controls to navigate to the location.

### BRIEF DESCRIPTION OF THE DRAWINGS

FIG. 1 is a block diagram schematically illustrating portions of an example mobile autonomous fleet control system.

FIG. 2 is a flow diagram of an example mobile autonomous fleet control method.

FIG. 3 is a block diagram schematically illustrating portions of a central control unit for use in a mobile autonomously control system.

FIG. 4 is a block diagram schematically illustrating portions of an example mobile autonomous fleet control system.

FIG. 5 is a block diagram schematically illustrating portions of an example mobile autonomous fleet control system.

FIG. 6 is a block diagram schematically illustrating portions of an example mobile autonomous fleet control system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein is an example mobile autonomous fleet control system, a mobile autonomous fleet control method and a self-propelled mobile slave unit. The example fleet control system, the example fleet control method and the example self-propelled mobile slave unit facilitate the provision of services at multiple locations by a fleet of managed mobilized service devices. The example fleet control system, the example fleet control method and the example self-propelled mobile slave unit facilitate the management and maintenance of a more efficient and lower cost fleet of mobile service devices that may be able to efficiently provide services throughout a larger zone of operation at a lower cost.

The example fleet control system, the example fleet control method and the example self-propelled mobile slave unit utilize a mobile master unit which is capable of leading any particular self-propelled slave unit of a fleet of self-propelled slave units. The mobile master unit is able to autonomously navigate, carrying out the higher level computations and environment sensing tasks associated with navigating through a master zone of operation. In contrast, each of the self-propelled slave units of the fleet operate or is operable with lower level computation and environmental sensing, simply following the lead of the mobile master unit. As a result, the fleet may be comprised of less complex, less expensive mobilized service units or slave units having fewer computational and sensing capabilities. Alternatively, the computational and power resources of the slave units, otherwise consumed by navigational tasks, may be utilized for other productive tasks or may be conserved, reducing power consumption, prolonging battery life, or increasing the distance that may be traveled by the slave unit prior to recharging.

For purposes of this disclosure, “autonomous navigation” means that a mobile unit is able to plan its route and move along the planned route, handling local obstacles and uncertainties during movement, without human assistance or intervention. In some circumstances, remote navigation aids may be employed during planning or movement along the route, while at other times the only information available to compute a mobile unit move along the route is based on input from sensors carried by the mobile unit itself. In the example illustrated, the mobile master unit may use navigation aids when available but may also rely on optical, sonic and chemical sensing. Once basic position information is gathered in the form of triangulated signals or environmental perception, machine intelligence may be applied to determine a route or plan. This route may accommodate the predicted or actual movement of other units, persons, animals or the like in order to prevent collisions. Prior routes or paths may be replaced with newer, presumably better routes or paths that accommodate the most current known conditions.

The self-propelled slave units receive follow commands, wherein the particular self-propelled slave unit that receives a follow command follows the mobile master unit to a location at which services are to be provided by the self-propelled slave unit. Once the particular self-propelled slave unit has been delivered to the service location, the particular slave unit may receive a release command, wherein the self-propelled slave unit enters a non-following state, providing requested services at the service location. In some implementations, the slave unit operates within a slave zone of operation, that is smaller than the master zone of operation, independent of the mobile master unit upon discontinuance of following of the mobile master unit.

In some implementations, the self-propelled slave units of the fleet may be heterogenous, offering different service capabilities or features. In some implementations, at least some of the self-propelled slave units of the fleet may include sensing and navigation controls sufficient to allow each self-propelled slave unit to autonomously navigate within a slave zone of operation that is smaller than the master zone of operation. In some implementations, the mobile master unit is carried by a person or other mobilized device. In yet other implementations, the mobile master unit, like the slave units, is self-propelled.

In one implementation, the multiple slave units of the fleet are managed by a central control unit. The central control unit processes new requests for services by the fleet. The central control unit further manages deployment of the slave units, tracking the position and movement of multiple mobile master units and the multiple self-propelled slave units of the fleet. The central control unit may contain or otherwise access a database of feature inventories. The feature inventories comprise the individual inventories of features of each self-propelled slave unit. Based upon such inventories of the individual slave units, their current location, rate of travel, expected time of completion for a current service task being executed and deadlines for a new service task or priorities for the new service task, the central control unit may schedule the delivery of particular self-propelled slave units two different service locations by the different mobile master units. Upon selecting a determining a particular self-propelled slave unit for performing a particular service task at a particular location in response to a received service request, the central control unit may issue a follow command to the particular slave unit. Similar scheduling may be performed for each of the available mobile master units and self-propelled slave units. In some implementations, the central control unit confirms completion of a service task as part of its scheduling.

In some implementations, the central control unit is distinct from each of the mobile master units and slave units. In some implementations, central control unit may be stationary, such as at a central location within the master zone of operation. In some implementations, the central control unit may be carried by an individual mobile master unit. In some implementations, the central control unit may output signals to the mobile master unit that carries the central control unit, wherein the signals direct the bowl master unit to move so as to remain within a communication range of each of the self-propelled slave units in the field.

Throughout the disclosure, the terms mobile master unit and slave unit are utilized. Each of the units may be in the form of a mechanical device that provides services. Each of the units may be in the form of a robot or a robotic device. Such a robotic device may have any of a variety of different forms depending upon the mode of propulsion as well as the service capabilities. In some implementations, the mobile master unit itself may be capable of performing selected services to satisfy service requests at particular service locations. Although the mobile master unit may or may not be self-propelled, each mobile master unit is capable of autonomous navigation. The slave units are self-propelled and are either operable in a lower navigation capacity state (also having an autonomous navigation mode/state) or which have limited navigation capabilities as compared to the mobile master unit. Whether actuated to the lower navigation capacity state or being provided with limited navigation capabilities, the slave units rely upon the mobile master unit for such autonomous navigation in busy and complex environments.

Disclosed is an example mobile autonomous fleet control system. The autonomous fleet control system comprises a central control unit to communicate with a mobile master unit, the mobile master unit to autonomously navigate, wherein the central control unit is to issue a follow command to a mobile self-propelled slave unit of a fleet of mobile self-propelled slave units, the follow command uniquely identifying the mobile master unit to be followed

Disclosed is an example mobile autonomous fleet control method. The method may comprise receiving a request for a service at a location. Thereafter, a particular self-propelled mobile slave unit of a fleet of self-propelled mobile slave units is determined or identified for providing the service. Each of the self-propelled mobile slave units of the fleet is operable to follow a mobile master unit. A follow command is issued to the particular self-propelled mobile slave unit directing the self-propelled mobile slave unit to follow the mobile master unit that is to autonomously navigate to deliver the particular self-propelled mobile slave unit to the location.

Disclosed is an example self-propelled mobile slave unit. The self-propelled mobile slave unit comprises a propulsion unit to propel the mobile slave unit and a mobile master unit identifier to identify a mobile master unit. The self-propelled mobile slave unit further comprises a follower unit to receive and execute a follower command to follow the mobile master unit is in a master zone of operation navigable by the mobile master unit to a slave zone of operation within the master zone of operation. The self-propelled mobile slave unit includes a slave operation unit operates a mobile slave unit within the slave zone of operation independent of the mobile master unit upon discontinuance of following of the mobile master unit.

FIG. 1 is a block diagram schematically illustrating portions of an example mobile autonomous fleet control system 20. System 20 comprises a central control unit 24 that is to communicate with a mobile master unit 30. The mobile master unit 30 is itself to autonomously navigate, determining a path or route throughout a region without human assistance or intervention. Such autonomous movement may be achieved by outputting control signals to a propulsion mechanism to move between locations or by outputting instructions or commands to a person or device carrying the mobile master unit 30 to carry the mobile master unit between locations.

Mobile master unit 30 may include various sensors for sensing environmental cues and receivers for receiving signals that, alone or in combination, are used by the mobile master unit 30 to identify its location. Such sensors may be optical sensors, contact sensors or sonic sensors. Such receivers may receive signals from a local location indicating transmitter or a remote location indicating transmitter, such as a global positioning system.

Mobile master unit 30 is “mobile” in that it is not fixed or stationary. In one implementation, mobile master unit 30 may be carried. For example, mobile master unit 30 may comprise a smart phone or other device carried by a person, but which directs the person to carry mobile master unit between locations. In yet other embodiments, mobile master unit 30 may be self-propelled, where in unit 30 includes a motor which drives mechanism for propelling unit 30, such as wheels, tracks, propellers and the like.

The central control unit 24 is to further issue a follow command to self-propelled slave units 42-1, 42-2 (collectively referred to as units 42) of a fleet 40. The follow command uniquely identifies a particular mobile master unit 30 to be followed. As a result, the particular self-propelled slave unit 42-1 or 42-2 follows the identified mobile master unit 30 two a service location to provide services at the service location.

In the example illustrated in FIG. 1, the mobile master unit 30 is able to autonomously navigate, carrying out the higher level computations and environment sensing tasks associated with navigating through a master zone of operation. In contrast, each of the self-propelled slave units 42 of the fleet 40 operate or is operable with lower level computation and environmental sensing, simply following the lead of the mobile master unit. As a result, the fleet 40 may be comprised of less complex, less expensive mobilized service units for slave units 42 having fewer computational and sensing capabilities. Alternatively, the computational and power resources of the slave units 42, otherwise consumed by navigational tasks, may be utilized for other productive tasks or may be conserved, reducing power consumption, prolonging battery life, or increasing the distance and may be traveled by the slave unit prior to recharging.

FIG. 1 further illustrates an example of the operation of system 20. As indicated by arrow 50, central control unit 24 directs a particular self-propelled slave unit 42-1 to follow mobile master unit 30. In response, slave unit 42-1 follows master unit 30 as indicated by arrows 52 as mobile master unit 30 leads slave unit 42-1 to a service location which was communicated to mobile master unit 30 as indicated by arrows 54. As indicated by broken lines, central control unit 24 may additionally issue a follower command to a second self-propelled slave unit 42-2 (as indicated by arrow 56 to directly (or indirectly) follow mobile master unit 30 to a same or different service location that was communicated to mobile master unit 30 as indicated by arrows 54. Such indirect following of mobile master unit 30 may be the second slave unit 42-2 actually following the first slave unit 42-1 in a train or chain.

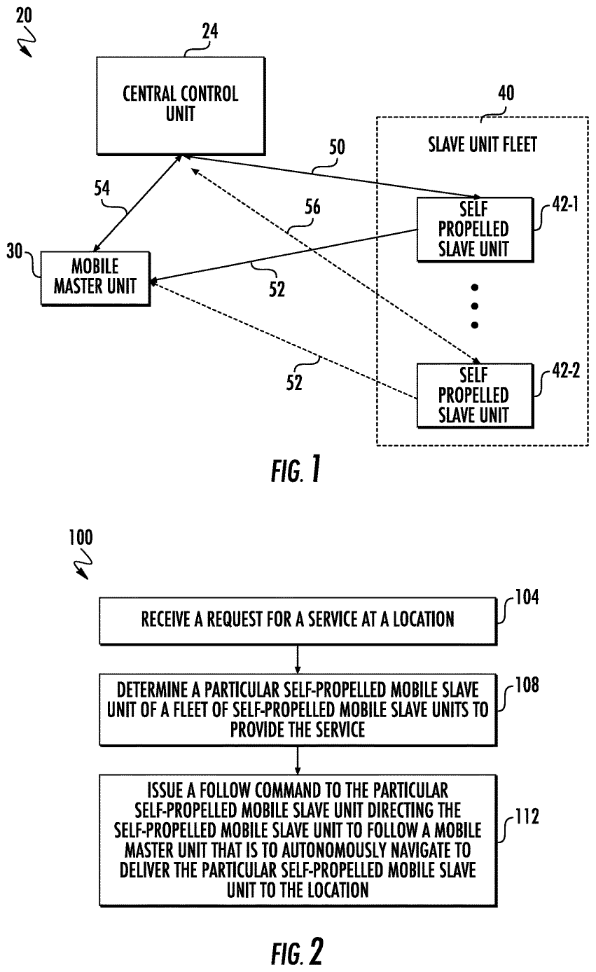

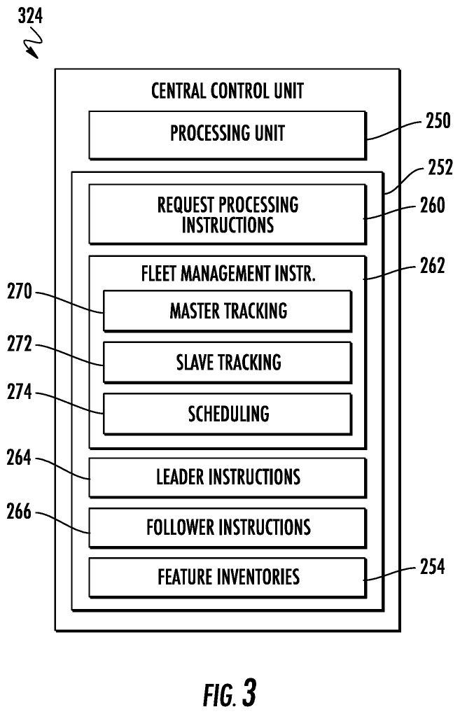

FIG. 2 is a flow diagram of an example mobile autonomous fleet control method 100. Method 100 facilitates the provision of services at multiple locations by a fleet of managed mobilized service devices. Method 100 facilitates the management and maintenance of a more efficient and lower cost fleet of mobile service devices that may be able to efficiently provide services throughout a larger zone of operation at a lower cost.

Method 100 utilizes a mobile master unit which is capable of leading any particular self-propelled slave unit of a fleet of self-propelled slave units. The mobile master unit is able to autonomously navigate, carrying out the higher-level computations and environment sensing tasks associated with navigating through a master zone of operation. In contrast, each of the self-propelled slave units of the fleet operate or is operable with lower level computation and environmental sensing, simply following the lead of the mobile master unit. As a result, the fleet may be comprised of less complex, less expensive mobilized service units or slave units having fewer computational and sensing capabilities. Alternatively, the computational and power resources of the slave units, otherwise consumed by navigational tasks, may be utilized for other productive tasks or may be conserved, reducing power consumption, prolonging battery life, or increasing the distance and may be traveled by the slave unit prior to recharging. Although method 100 is described in the context of being carried out by system 20, it should be appreciated that method 100 may likewise be carried out by any of the systems described hereafter or with other similar systems.

As indicated by block 104, a request for a service at a location is received. The service may be the delivery or provision of supplies or materials by a mobilized service device and/or the performance of an action or operation by the mobilized service device. For example, the request may be that a particular amount of material or supplies be delivered to a particular location for use at the location. The request may be for the mobilized service device itself to carry out or perform actions at the service location, such as presenting a display of information and/or moving or interacting with other objects, animals or persons at the service location. For example, in one implementation, the mobilized service device, a self-propelled slave unit, may constitute a cart which carries materials or supplies. In one implementation, the mobilized service device or self-propelled slave unit may comprise an infusion pump. In yet other implementations, will I service device self-propelled slave unit may deliver a variety of other materials or other interactions to a service location.

As indicated by block 108, upon receiving the request, a particular self-propelled mobile slave unit (a mobilized service device) of a fleet of such units, is determined identified for providing the requested service. The determination of selection of the particular mobile slave unit of the fleet may be based upon several factors such as the current location of the mobile slave unit relative to the locations of the other slave units of the fleet, the progress or state of any service task currently in progress and being performed by the particular mobile slave unit relative to that of other slave units, the proximity of the particular mobile slave unit to a mobile master unit for delivering the particular slave unit to the service location, and the set of features are capabilities of the particular mobile slave unit relative to the other mobile slave units. In some implementations, the particular slave unit chosen for servicing the request may at least be partially based upon a priority given to the request. In some implementations where charges are made to the requester for the service, the selection of the particular slave unit for satisfying the request may be based upon an identity of the requester, a subscription level (premium, standard, low-cost) associated with requester, the price paid by the requester and/or a priority of the requester or of the service being requested. For example, the satisfaction of certain requests may be automatically given a higher priority as compared to other requests based upon different consequences that may result from the time at which the request is satisfied. In some implementations, the selection of the particular self-propelled slave unit for satisfying the request may be simply based upon the position of the particular self-propelled slave unit in a queue awaiting assignments.

As indicated by block 112, upon determining which particular self-propelled slave unit 42-1, 42-2 is to satisfy the request, a follow command is issued to the chosen self-propelled mobile slave unit. The follow command directs the self-propelled mobile slave unit to follow a mobile master unit, wherein the mobile master unit autonomously navigates to deliver the particular chosen self-propelled mobile slave unit to the service location. During such delivery of the self-propelled mobile slave unit to the service location, the mobile master unit carries out the higher level computations and environment sensing tasks associated with navigating through a master zone of operation. In contrast, the self-propelled slave units of the fleet operate with lower level computation and environmental sensing, simply following the lead of the mobile master unit. The chosen self-propelled slave unit simply maintains sufficient communication or tracking of the mobile master unit so as to follow the mobile master unit.

FIG. 3 is a block diagram illustrating an example central control unit 224 which may be utilized in place of central control unit 24 and which may carry out method 100 described above. In one implementation, central control unit 224 unit is distinct from each of the mobile master units 30 and slave units 42. In some implementations, central control unit 224 may be stationary, such as at a central location within the master zone of operation. In some implementations, the central control unit 224 may be carried by an individual mobile master unit 30. In some implementations, the central control unit 224 may output signals to the mobile master unit 30 that carries the central control unit 224, wherein the signals direct the mobile master unit 30 to move so as to remain within a communication range of each of the self-propelled slave units 42 in the field.

Central control unit 24 comprises processing unit 250 and a non-transitory computer-readable medium 252. Processing unit 250 carries out the instructions, sometimes in the form of a computer program or code, contained or read from medium 252. In some implementations, processing unit 250 may be distributed amongst various processors.

Medium 252 comprises a storage medium that stores data and further contains instructions for directing the operation of processing unit 250. Medium 252 may be in the form of a memory, such as nonvolatile memory such as a flash memory or disk. Medium 252 comprises feature inventories 254, request processing instructions 260, fleet management instructions 262, leader instructions 264 and follower instructions 266. Feature inventories 254 comprises a database or storage table identifying each of the mobile master units 30 and slave units 42 of fleet 40. Feature inventories 254 may further store and provide the various capabilities or features of each of the self-propelled slave units 42 of fleet 40 managed by central control unit 224. Such feature inventories may also include or identify those features of mobile master unit 30. In some implementations, medium 252 may omit feature inventories 254, where feature inventories 254 are remotely located and accessed by central control unit 224 through a wired or wireless network.

Request processing instructions 260 direct processing unit 250 to carry out method 104 of method 100 described above. In some implementations, request processing instructions 260 may direct processing unit 250 to authenticate the identity of a requester requesting such services. In some implementations, request processing instructions 260 may restrict particular service requests depending upon the identity of the requester. In some implementations, request processing instructions 260 may direct processing unit 250 to provide a requester with a menu of service options from which a requester may make a selection. In some implementations, the request process instructions 260 may further prompt the requester to assign a priority to the request or to provide compensation for the requested service.

Fleet management instructions 262 direct processing unit 250 to manage the fleet 40 of self-propelled slave units 42 with respect to mobile master unit 30. Fleet management instructions 262 comprise master tracking instructions 270, slave tracking instructions 272 and scheduling instructions 274. Master tracking instructions 270 direct processing unit 250 to track the current location as well as scheduled destinations for each of the mobile master units 30. Slave tracking instructions 272 direct processing unit 250 to track the current location as well as scheduled destinations for each of the self-propelled slave units 30. The tracked positions of the mobile master units 30 and slave units 42 may be stored for retrieval.

Scheduling instructions 274 direct processing unit 250 to schedule the use of particular self-propelled slave units for satisfying particular received service requests. Scheduling instructions 274 may further direct processing unit 250 to additionally schedule use of particular mobile master units 30 for delivering the particular self-propelled slave unit or units to the service locations. Following such instructions, processing unit 250 may take into account or evaluate the type of service or task being requested, the capabilities or features of the different available self-propelled slave units 42 (as determined from the feature inventories 254), the authority, status or priority given to a particular task type or the particular requester of the service, and the proximity of the service location to the available self-propelled slave units. In some circumstances, such instructions may direct the processing unit 252 interrupt a current task or service being carried out by a particular self-propelled slave unit, redirecting the particular self-propelled slave unit for a higher priority task as appropriate. Such scheduling instructions may additionally take into account the predicted route or path for such slave propelled slave units when being delivered to their service locations by mobile master unit 30 so as to avoid collisions. In some implementations, scheduling instructions 274 may direct processing unit 250 to additionally take into account, when scheduling particular self-propelled slave units 42 for service tasks, predetermined and/or camera/sensor monitored human or animal traffic patterns based upon the time of day, time of the week or time of the year.

Leader instructions 264 and follower instructions 266 direct processing unit 250 to communicate, through a transceiver or transmitter, with the various mobile master units 30 and self-propelled slave units 42 under the purview of central control unit 224. Once a particular self-propelled slave unit 42 has been scheduled for satisfying a received service request at a location and once a particular mobile master unit 30 has been chosen to deliver the particular self-propelled slave unit 42 to the service location, leader instructions direct processing unit 250 identifier communicate to the particular mobile master unit 30, the service location which will be the destination for the mobile master unit 30. Leader instructions 264 may further cause a processing unit 250 to communicate a path that is to be taken by mobile master unit 30 when delivering the particular chosen self-propelled slave unit 42 to the service location. For example, processing unit 250 may direct the mobile master unit 30 to initially travel to a pickup location or destination for picking up or non-physically linking with the particular self-propelled slave unit 42 prior to traveling to the service location. In some implementations, the mobile master unit 30 may be given multiple pickup destinations or locations where mobile master unit 30 is to initially direct a chain or train of self-propelled slave units 42 to multiple service locations, each service location to receive at least one slave unit 42. Although may be given a path, a speed to travel, a time to travel as well as different destinations, the precise maneuvering through or along the path, avoiding obstacles, moving persons, moving animals or other in certainties is performed by the particular mobile master unit 30 itself, autonomously.

Follower instructions 264 comprise instructions that direct processing unit 250 to cause signals to be transmitted, such as in a wireless fashion, to the particular self-propelled slave unit 42, directing the particular self-propelled mobile slave unit to follow the mobile master unit 30. Such signals may indicate the time at which the mobile master unit 30 is expected to arrive, wherein the self-propelled slave unit 42 will begin sensing its surrounding environment “looking for” the mobile master unit 30 during a predefined time window about the expected arrival time for the mobile master unit 30. Such signals will further include an identification of the mobile master unit 30 which is to be followed by the particular self-propelled slave unit. The particular self-propelled slave unit 30 will utilize such identification information to distinguish mobile master unit 30 from other mobile master units 30 and to track and follow the mobile master unit 30 as the mobile master unit 30 delivers the particular self-propelled slave unit 42 to the service location.

In some circumstances, processing unit 250, following scheduling instructions 274, may determine that a more efficient service schedule may be achieved with a single mobile master unit 30 concurrently moving multiple slave units 42 as a train or chain towards multiple different service locations for the multiple slave units 42. For example, where to service locations are adjacent one another, the processing unit 250 may determine it to be more efficient for a mobile master unit to lead a chain of two slave units to the service locations, dropping off the slave units at the respective service locations (rather than delivering a first service unit to the first service location, coming all the way back to pick up a second slave unit and then delivering the second slave unit to the second service location adjacent the first service location). In circumstances where processor 250, following scheduling attracted 274, determined that such a chain or train is more efficient, follow instructions 266 may direct processing unit 250 to first instruct a first slave unit 42 to follow the chosen mobile master unit 30 and then instruct a second different slave unit 42 to follow the first slave unit 42. In such an implementation, each slave unit 42 may itself include an identifier that may be sensed by other slave units 42. In the example being described, the follow instructions may direct the processing unit 250 to output signals that identify the identifier of the first slave unit which is to be followed by the second slave unit.

Once the mobile master unit 30 reaches a service location, as autonomously determined by the mobile master unit 30, the mobile master unit 30 may release the particular slave unit 42 scheduled to provide services at the service location. In particular, the mobile master unit 30 may output a release signal to the slave unit 42, wherein the slave unit 42 will switch to a non-following state or a servicing state at the servicing location. In one implementation, the scheduling instructions 274 may further determine the appropriate order of the slave units 42 behind the mobile master unit 30, based upon the location of the different service locations, wherein the order of the slave units following the mobile master unit 30 will be in a reverse order with respect to the order that the slave units 42 will be dropped off or released from the mobile master unit 30. In other words, the first slave unit to be dropped off or released from the mobile master unit 30 will be the last slave unit of the series of slave units, the “caboose”.

In some implementations, the order of the slave units in the series may be reordered or rearranged during transit. For example, in circumstances where the route or path being taken by the master unit changes due to changes in circumstances, such as changes in human or animal traffic, changes in priority or demand or other changes, such as an elevator being out of service or the like, the central control unit may output control signals to at least one of the slave units of the series directing the individual slave units of the series to reorder by issuing new follower commands. For example, the new follower commands may direct a different slave unit of the series to follow the master unit and may direct a slave unit currently following the master unit to alternatively follow one of the slave units of the series. The new follower commands may direct a particular slave unit to follow a different slave unit than the one currently being followed. In some circumstances, such rearrangement of slave units may take place prior to any slave units being released from the series or at any time after a first slave unit of the series has been released from the master unit. In some circumstances, due to a change in the path or route being taken by the master unit, a particular slave unit of the series may be instructed to disconnect a release from the train or series and temporarily park at a given location, wherein the master unit may be directed to later return to the park location to retrieve the previously released slave unit and deliver the previously the released slave unit to its targeted service location.

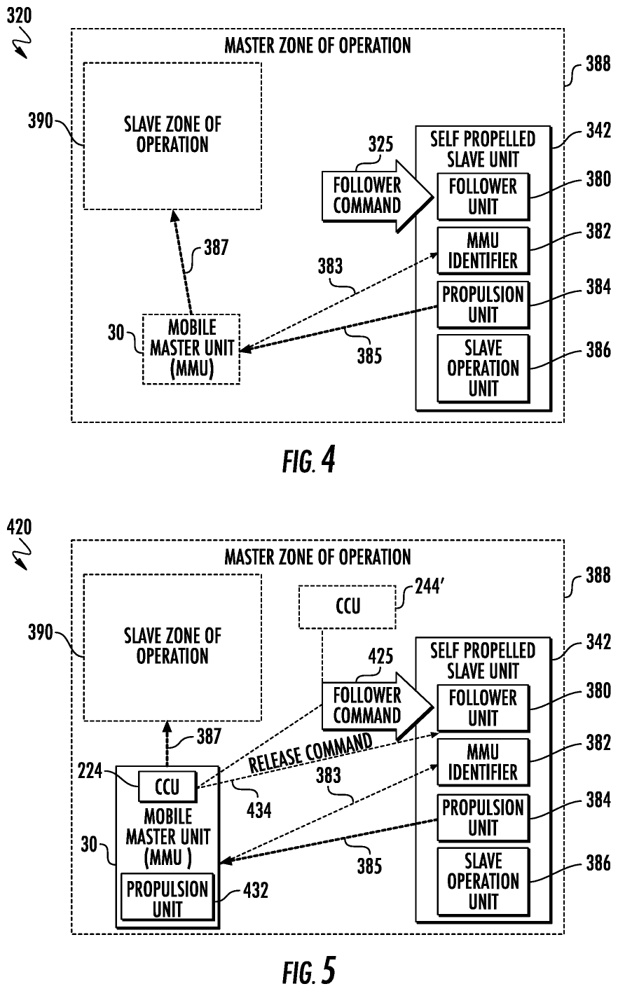

FIG. 4 is a block diagram schematically illustrating portions of an example mobile autonomously control system 320. System 320 may employ a fleet of self-propelled slave units 342, one of which is shown. Each self-propelled slave unit 342 comprises follower unit 380, mobile master unit identifier 382, propulsion unit 384 and slave operation unit 386. Follower unit 380 comprises a portion of slave unit 342 that receives and processes follower commands that are received from a central control unit, such as central control unit 24 described above. In some implementations, follower unit 380 may store and queue different follower commands for processing in the order in which they were received. In some implementations, follower unit 380 may additionally carry out authentication operations, authenticating the identity of the central control unit 24 providing slave unit 342 with the follower command. In circumstances where slave unit 342 is already occupied carrying out a previously requested service task or is unavailable, such as being down for upgrading or repairs, follower and unit 380 may respond to central unit 24 or preemptively provide center control unit 24 with notifications of its unavailability.

Follower unit 380 further supervises or controls the following of the mobile master unit 30. In particular, upon receiving a follower command 325, and potentially after verifying the authenticity of the follower command based upon the authenticated identity of the central control unit, follower unit 380 triggers mobile master unit identifier 382. As indicated by arrows 383, mobile master unit identifier 382 assists in identifying the mobile master unit 30 which is to be followed by slave unit 342 pursuant to the received follower command. Mobile master unit identifier 382 may include sensing technology, such as optical, Blu-ray, auditory or other wireless sensing technology that senses the presence of mobile master unit 30 as well as information to identify the particular mobile master unit 30. In one implementation, the mobile master unit 30 may include identifying information, such as a barcode, QR code or other indicia which may be sensed by identifier 382 to determine the identification of the mobile master unit 30. In some implementations, identifier 32 may wirelessly communicate with a candidate mobile master unit 30 to learn and verify the identity and authenticity of the mobile master unit 30 through a keyword-password exchange.

Upon identifying the particular mobile master unit 30 as the mobile master unit 30 that is to be followed pursuant to follow instructions or commands 380, which are generated based upon a service request received by the central control unit 24 (described above), follow unit 380 continues identify unit 30 and track movement of the mobile master unit 30 (using signals from identifier 382) at least until the slave unit has been delivered to the service location. Based upon the identification and tracking of mobile master unit 30, follower unit 380 generates control signals (using processor following instructions stored on non-transitory computer-readable medium) to propulsion unit 384 to propel slave unit 342 to follow mobile master unit 30, maintaining the slave unit 342 within a predetermined distance or range of distances with respect to mobile master unit 30. As indicated by arrow 385, propulsion unit 384 propels or moves slave unit 342 to follow mobile master unit 30 which autonomously navigates to a slave zone of operation 390 as indicated by arrow 387. Propulsion unit 384 may comprise an engine or motor which drives ground engaging members such as wheels or tracks, which drives jets or propellers for moving through liquid or water and/or may comprise an engine or motor for driving propellers such as where slave unit 342 may be an airborne vehicle such as a helicopter, plane or drone.

The slave zone of operation 390 may comprise a distinct subregion or portion within a larger master zone of operation 388 which is autonomously navigable by mobile master unit 30. In some implementations, the master zone of operation 388 may comprise a building, floor or the like, wherein slave zone of operation 390 comprises a smaller portion such as an individual room of a floor or building, an individual floor of a multi-floor building or the like. By following mobile master unit 30, slave unit 342 may rely upon the enhanced navigation, map following, environmental sensing and adaptation capabilities of mobile master unit 30 to avoid obstacles and unpredictable uncertainties such as person and animal traffic as it is being delivered to the slave zone of operation 390. As expounded upon above, this may allow self-propelled unit 342 to omit such enhanced sensing componentry, reducing the cost and complexity of slave unit 342.

Once mobile master unit 30 has arrived at the slave zone of operation 390, mobile master unit 30 may issue a release command causing self-propelled slave unit 342 entry non-following state or a servicing state. Thereafter, master unit 30 may continue delivering additional slave unit 342 which may also be following mobile master unit 30 or which were followed by the now dropped off slave unit 342. Once all of the slave units 342 have been dropped off, mobile master unit 30 may travel to its own service location for satisfying a service request, may be directed by the central control unit 24 to pick up new or additional slave units 342 or may return to a predetermined location or base for charging or the like.

Slave operation unit 386 comprises componentry on slave unit 342 for carrying out service tasks. Slave operation and 386 may further direct the movement or operation of such components within a particular slave zone of operation, such as zone 390. Slave operation unit 36 may include components that interact with the surrounding environment or articles. For example, slave operation unit 36 may comprise robotic arms, grippers, connectors, pumps, conveyors, sprayers or any other components that may be powered and turned on and off to perform a service or task. Slave operation unit 386 perform such tasks after being released from mobile master unit 30, independent of any control by or assistance from mobile master unit 30. In some implementations, slave operation and 36 may cooperate with corresponding master operation units on mobile master unit 30, wherein both the mobile master unit 30 and the slave operation unit 386 cooperate to satisfy service request at a service location.

FIG. 5 is a block diagram schematically illustrating portions of mobile autonomously control system 420. System 420 is similar to system 320 except that system 420 is additionally illustrated with mobile master unit 30 comprising the central control unit 224 and a propulsion unit 432. Central control unit 224 is similar to the central control unit 224 described above except that center control unit 24 specifically illustrated as being carried by mobile master unit 30. In one implementation, central control unit 224 may manage other mobile master units 30 as well as different fleets of self-propelled slave units 342. As shown in broken lines, in other implementations, system 420 may additionally or alternatively comprise central control unit 224′ which is not carried by mobile master unit 30. Central control unit 224′ may be fixed or stationary proximate the master zone of operation 388 or maybe mobile, carried by a person or by another mobile vehicle. In some implementations, system 420 may comprise both center control unit 24 and central control unit 224′, providing a distributed central control unit.

Propulsion unit 432 is part of mobile master unit 30. Propulsion unit 432 provide self-propulsion capabilities to mobile master unit 30. Like propulsion unit 34, proposing unit 432 may comprise an engine or motor which drives ground engaging members such as wheels or tracks, which drives jets or propellers for moving through liquid or water and/or may comprise an engine or motor for driving propellers such as where mobile master unit 30 may be an airborne vehicle such as a helicopter, plane or drone.

As shown by FIG. 5, during operation, central control unit 224 and/or 224′ issues a follower command 425 to follower unit 380 of a particular self-propelled slave unit 342 (chosen by the central control unit 224 following scheduling instructions 274 described above). Follower unit 380, upon authenticating the central control unit which provided the follower command 425, causes MMU identifier 382 to identify the mobile master unit 30 to be followed as indicated by arrow 383. In some implementations, mobile master unit 30 senses when it is being identified by self-propelled slave unit 342, wherein mobile master unit 30 outputs an identification signal and/or becomes or stays in a stationary state as such identification is completed.

As indicated by arrow 385, follower unit 380 follows by generating control signals for propulsion unit 384 to follow mobile master unit 30. As indicated by arrow 387, autonomously navigates to the slave zone of operation 390, using propulsion unit 432 and using the enhanced sensors, mapping and other navigation capabilities to reach slave zone 390 within the larger master zone of operation 388. As indicated by arrow 434, upon determining that it has reached the slave zone of operation 390, mobile master unit 30 issues a release command, a wireless signal to self-propelled slave unit 342 causing propelled slave unit 342 to cease the following of mobile master unit 30 and indicating to the slave unit 342 that it has been delivered to its destined slave zone of operation 390 for performing a service task. Thereafter, the slave operation at 386 may assume control, providing the requested service in the slave zone of operation 390.

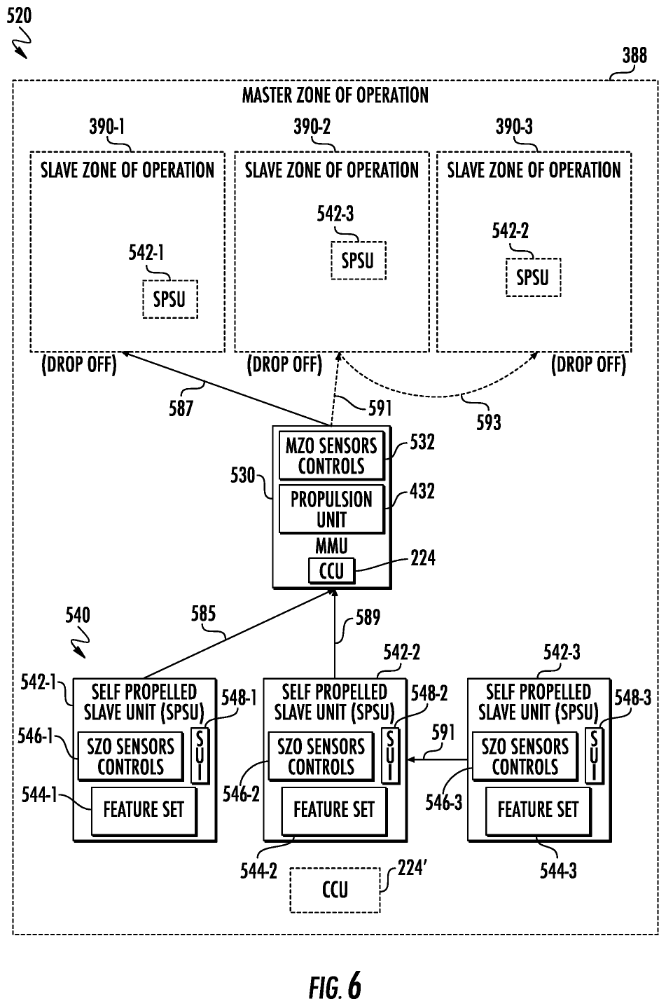

FIG. 6 is a block diagram schematically illustrating portions of an example autonomously control system 520. System 520 is similar to system 420 described above except that system 520 comprises mobile master unit 530 and a fleet 540 of self-propelled slave units 540 2-1, 542-2 and 542-3 (collectively referred to as units 540), amongst other mobile master units and slave units. Those remaining components of system 520 which correspond to components of system 420 or other above described systems are numbered similarly.

Mobile master unit 530 is similar to mobile master unit 30 described above with respect to system 420 except that mobile master unit 530 is specifically illustrated as comprising master zone of operation (MCO) sensors and controls 532. Sensors and controls 532 comprise sensing and control componentry that facilitates autonomous navigation of mobile master unit 530 within the master zone of operation 388. In some implementations, the master zone of operation 388 may be unlimited. In other implementations, the master zone of operation may be a restricted zone of operation, such as a particular facility, a particular acreage, a particular building, a particular floor of the building or the like. Each master zone of operation 388 may include multiple subregions or sub-zones, slave zones of operation such as zones 390-1, 390-2 and 390-3 (collectively referred to as zones 390).

Sensors and controls 532 may include at least one of transceivers for communicating with a global positioning system or other location indicating signal source and/or optical, sonic/ultrasonic, audible or wireless sensors. One example of such a wireless sensor may comprise a Bluetooth or received signal strength indication (RSSI) sensor. Sensors and controls 532 edition include electronics or control circuitry that utilizes such signals to react to the surrounding environment during travel of mobile master unit 530 within zone of operation 388. For example, sensors and controls 532 may react to human, animal/pet or other mobile master unit traffic along the route of mobile master unit 530, wherein the travel speed and/or path or route may be temporarily altered to accommodate such traffic. Upon the temporary “obstacle” no longer being present, the original speed and/or route may be resumed. In some implementations, the speed and/or route may be permanently altered as a result of the obstruction/obstacle. In some implementations, the speed and/or route of the mobile master unit 530 may be increased or altered to make up for lost time resulting from the temporary stoppage or slow down that occurred to avoid the collision or to avoid the obstacle. Controls 532 may further respond or react to sensed unanticipated conditions that may result in unsafe or unreliable operation such as a fire alarm activation or low battery levels.

Self-propelled slave units 542-1, 542-2, 542-3 are similar to slave units 342 described above, including those units illustrated in FIGS. 4 and 5, except that slave units 542 are further illustrated as comprising feature sets 544-1, 544-2, 544-3 (collectively referred to as feature sets 544), slave zone of operation sensors and controls 546-1, 546-2 and 546-3 (collectively referred to as controls 546) and slave unit identifiers 548-1, 548-2 and 548-3 (collectively referred to as slave unit identifiers 548), respectively. Feature sets 544 comprise sets of features, such as sets of slave operation units 386 (described above) for carrying out service tasks at service locations. In one implementation, each of the slave units 542 may have a same feature set 544. In other implementations, feature sets 544 may be different from one another. Such features may be stored in future inventories 254 of central control unit 224 as described above, wherein the central control unit 224 may schedule a particular one of the slave units 542, following scheduling instructions 274, based upon the particular feature sets associated with each particular slave unit 542.

Controls 546 comprise the sensors and electronics of each of slave units 542 that control the following of a mobile master unit 530 by the particular slave unit 542. Controls 546 may incorporate the MMU identifier 382 (described above). In one implementation, controls 546 may be substantially similar to controls 532 of mobile master unit 530, but where the slave unit 542 is operable in a mode where not all of the capabilities are employed to conserve computing bandwidth and/or power. In another implementation, controls 546 may have lower overall capabilities as compared to controls 532, such as lacking the ability to autonomously navigate throughout the master zone of operation 388 and/or lacking the ability to independently avoid temporary or unpredictable obstacles such as traffic within the master zone of operation 388. For example, controls 546 may lack or omit a transceiver for communicating with a global positioning system or for communication with an indoor location system. Controls 546 may lack or omit optical sensors or touch/contact sensors. Although possibly including optical sensors or audible sensors capable of following are tracking a mobile master unit 30 within a particular range of distance, such controls 546 may lack or omit the capability of longer-range sensing such as sensing services or objects at a distance greater than the predefined tracking or following range distance of mobile master unit 530. Controls 546 may lack the resolution otherwise used for identifying unexpected traffic or other obstacles. Controls 546 may lack the processing speed and/or power to react to traffic or other obstacles in a timely fashion. For example, controls 546 may have a lower reaction time as compared to the reaction time of controls 532 four responding or reacting to an unexpected obstruction such as human/animal traffic or the like. Because each of slave units 542 may include navigation or environmental sensing capabilities less than that of mobile master unit 530, instead relying upon the capabilities of mobile master unit 530, each slave unit 542 may be less complex, lower weight, more compact and/or lower cost.

Slave unit identifiers 548 may be similar to the mobile master unit identifiers except that slave unit identifiers facilitate the identification of a particular slave unit 542 by another slave unit 542. Slave unit identifiers 548 may comprise an audible signal generating component or a visual signal generating component, the signal identifying the particular slave unit. In some implementations, the slave unit identifiers 540 may each comprise a distinct indicium such as a barcode, QR code or other indicia which may be sensed by the MMU identifier 382 of another slave unit 542 to determine the identification of the slave unit 542. In some implementations, the slave unit identifier 548 may wirelessly communicate its identity to another slave unit 542. Slave unit identifiers 548 may facilitate the linking of slave units 542 to one another in a chain or series such that multiple slave units 542 may follow a single mobile master unit 530 in succession or in a train.

FIG. 6 identifies example deliveries of multiple slave units 542 to different slave zones of operation 390 for providing service tasks at the different slave zones of operation. As indicated by arrow 585, mobile master unit 530 may be first instructed by central control unit 224 and/or 224′ to deliver slave unit 542-1 to slave zone of operation 390-1. Based upon such instruction, mobile master unit 530 may autonomously navigate to a location in sufficient proximity with slave unit 542-1 such a slave unit 542-1 may identify mobile master unit 530. Central control unit 224 and/or 224′ may issue a follower command to the slave unit 542-1, wherein the slave unit 542-1 will follow the master control unit 530 as it atomically navigates to the slave zone of operation 390-1 as indicated by arrow 587. Upon reaching the slave zone of operation 390-1 with the non-physically “towed” slave unit 542-1, mobile master unit 530 may issue a release command (or central control unit 224 and/or 224′) may issue a release command to the slave unit 542-1, causing slave unit 542-1 to no longer follow mobile master unit 530, but instead switch to a park mode or service mode for carrying out his designated service tasks within the slave zone of operation 390-1.

Thereafter, mobile master unit 530 may receive new instructions from central control unit 224 and/or 224′ or may withdraw from a storage queue the next successive delivery to be carried out. Mobile master unit 530 may autonomously navigate to the location and proximity to slave unit 542-2, where slave unit 542-2 is allowed to identify mobile master unit 30 and is to receive a follow command to follow mobile master unit 530. Once slave unit 542-2 has been placed in tow (as indicated by arrow 589), mobile master unit 530 may autonomously navigate to a location within sufficient proximity to slave unit 542-3 such as slave unit 542-3 may identify mobile master unit 530 and/or slave unit 542-2. Slave unit 542-3 may receive a follow command from central control unit 224 and/or 224′directing slave unit 542-3 to follow slave unit 542-2, using the slave unit identifier 548-2 of slave unit 542-2. Once mobile master unit 530 has determined that slave unit 542-3 is in tow (as indicated by arrow 591), mobile master unit 530 may autonomously navigate through master zone of operation 388, as indicated by arrow 591 and following the instruction provided by central control unit 224 and/or 224′, to slave zone of operation 542-3. Upon determining its arrival at the slave zone of operation 542-3, mobile master unit 530 (or central control unit 224 and/or 224′) may issue a release command to the last or “caboose” slave unit 542-3, causing the slave unit 542-3 to stop following slave unit 542-2 and enter a park or servicing state for satisfying the service request within the slave zone of operation 390-2. Thereafter, as indicated by arrow 593, slave unit 530 may autonomously navigate to slave zone of operation 390-3 with slave unit 542-2 in a nonphysical or wireless tow. Upon determining that it is arrived at the slave zone of operation 390-3, the mobile master unit 530 (or the central control unit 224 and/or 224′) may issue a release command to the mobile master unit 542-2, causing the mobile master unit 542-2 to enter a park or service mode for satisfying the service request at the slave zone of operation 390-3. Thereafter, mobile master unit 530 may communicate with central control unit 224 and/or 224′indicating the completion of the deliveries. Mobile master unit 530 may then proceed to an additional zone of operation to provide satisfying service task or may await further instruction for additional deliveries of slave units different slave units 542. In some implementations, mobile master unit 530 may await completion of the service tasks by at least one of the slave units 542-1, 542-2, 542-3, wherein the mobile master unit 530 will retrieve such slave units and deliver them to their next assigned slave zones of operation for carrying out their next service tasks.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A mobile autonomous fleet control system comprising:
a central control unit to communicate with a mobile master unit, the mobile master unit to autonomously navigate, wherein the central control unit is to issue a follow command to a mobile self-propelled slave unit of a fleet of mobile self-propelled slave units, the follow command uniquely identifying the mobile master unit to be followed.

2. The system of claim 1, wherein the central control unit is to issue a release command to a particular mobile slave unit of the fleet, directing the particular mobile slave unit to stop following the mobile master unit.

3. The system of claim 1, wherein the central control unit is to manage services to be provided by different mobile self-propelled slave units of the fleet at different locations and is to schedule delivery of the different mobile self-propelled slave units of the fleet to the different locations by the mobile master unit.

4. The system of claim 1, wherein the mobile master unit is to autonomously navigate in a master zone of operation and wherein each of the mobile self-propelled slave units of the fleet is operable independent of the master unit within a slave zone of operation smaller than the master zone of operation.

5. The system of claim 1 further comprising the mobile master unit.

6. The system of claim 5, wherein the mobile master unit carries the central control unit.

7. The system of claim 5, wherein the mobile master unit is self-propelled.

8. The system of claim 5, wherein the mobile master unit comprises an identifier to identify the mobile master to each of the mobile slave units of the fleet.

9. The system of claim 1 further comprising the fleet of mobile slave units.

10. The system of claim 9, wherein the mobile master unit has a first set of available features and wherein a particular mobile slave unit of the fleet has a second set of available features different than the first set of available features.

11. The system of claim 9, wherein a first particular mobile slave unit of the fleet has a first unique slave unit identifier, wherein a second particular mobile slave unit of the fleet has a second unique slave unit identifier different than the first unique slave unit identifier and wherein the central control unit is to issue a follow command to the second particular mobile slave unit directing the second particular mobile slave unit to follow the first mobile slave unit based upon the first unique slave unit identifier.

12. A mobile autonomous fleet control method comprising:
receiving a request for a service at a location;
determining a particular self-propelled mobile slave unit of a fleet of self-propelled mobile slave units to provide the service, each self-propelled mobile slave unit of the fleet being operable to follow a mobile master unit;
issuing a follow command to the particular self-propelled mobile slave unit directing the self-propelled mobile slave unit to follow the mobile master unit that is to autonomously navigate to deliver the particular self-propelled mobile slave unit to the location.

13. The method of claim 12, wherein the master unit is to autonomously navigate within a master zone of operation and wherein the particular self-propelled mobile slave unit is operable independent of the master unit within a slave zone of operation smaller than the master zone of operation.

14. A self-propelled mobile slave unit comprising:
a propulsion unit to propel the mobile slave unit;
a mobile master unit identifier to identify a mobile master unit;
a follower unit to receive a follow command to follow the mobile master unit within a master zone of operation navigable by the mobile master unit to a slave zone of operation within the master zone of operation; and
a slave operation unit to operate the mobile slave unit within the slave zone of operation independent of the mobile master unit upon discontinuance of following of the mobile master unit.

15. The self-propelled mobile slave unit of claim 14, wherein the mobile master unit has a first set of available navigation features and wherein the self-propelled mobile slave unit has a second set of available navigation features less than the first set of available features.
